(19) United States
(12) Patent Application Publication
(10) Pub. No.: US 2018/0247022 A1
(43) Pub. Date: Aug. 30, 2018

(54) MEDICAL TREATMENT SYSTEM

(71) Applicant: INTERNATIONAL BUSINESS MACHINES CORPORATION, ARMONK, NY (US)

(72) Inventor: David L. Kaminsky, Chapel Hill, NC (US)

(21) Appl. No.: 15/442,150

(22) Filed: Feb. 24, 2017

(51) Int. Cl. G06F 19/00; G06N 99/00

(52) U.S. Cl. CPC G06F 19/325; G06N 99/005; G06F 19/345; G06F 19/328

(57) ABSTRACT

Systems, methods and tools for leveraging computer networking resources, predictive analytics, machine learning technologies and artificial intelligence systems to predicts diagnoses, estimate costs associated with treating the diagnoses and allow patients to remotely schedule treatment with healthcare providers, based on the estimated costs provided. The patient may input relevant user information into the cost scheduling system via the scheduling portal and known symptom information to receive a potential diagnosis. The patient's client device may receive a report generated by the system describing each healthcare provider's expected costs for administering treatment based on the anticipated diagnosis. A patient, receiving the health care cost estimates from each provider may use the patient's client device to select the desired health care provider and schedule an appropriate time for commencing treatment of the patient.

### TECHNICAL FIELD

The present disclosure relates generally to systems, methods and tools for diagnosing medical issues, estimating costs, and scheduling medical treatment.

### BACKGROUND

Health care services are unlike most other services offered or purchased regularly by consumers in the United States. These services are amongst the most complex to understand and navigate. In most of the potential interactions in this industry between a service recipient (e.g., a patient) and a service provider (e.g., a doctor), multiple third parties, with different interests, play different roles. These third parties include, for example, private insurance providers, the U.S. government, owners of service facilities such as hospitals and nursing homes, ambulance services providers, pharmacies, nurses, specialty care, etc.

The selection of healthcare services, products and providers may be difficult for consumers to receive accurate cost information. Often, meaningful healthcare information is unavailable to consumers. For example, health-related costs to the consumer in any given market, for any given procedure, may vary. Consumers may not have access to the current costs they may incur for receiving a health-related service or product. In addition, the quality of care may vary within any given market. For example, various providers may have differing levels of experience or skill for a given procedure, product or service, but this information typically is not available to consumers. As a result, consumers often make choices concerning their healthcare products, service and/or providers without the benefit of accurate cost and quality information.

### SUMMARY

A first embodiment of the present disclosure provides a method for estimating health care costs of a patient comprising the steps of: collecting, by a processor, symptom data from the patient; analyzing, by the processor, the symptom data; diagnosing, by the processor, a disorder of the patient as a function of the symptom data; retrieving, by the processor, a cost schedule from a data source; calculating, by the processor, a cost for treating the disorder as a function of an insurance cost schedule for each healthcare provider accessible to the patient; transmitting, by the processor, the cost and an availability schedule of each healthcare provider to the patient; receiving, by the processor, user input selecting a healthcare provider from the availability schedule; and scheduling, by the processor, treatment with the healthcare provider as a function of the user input.

A second embodiment of the present disclosure provides a computer system comprising a processor; a memory device coupled to the processor; and a computer readable storage device coupled to the processor, wherein the storage device contains program code executable by the processor via the memory device to implement a method for estimating health care costs of a patient comprising the steps of: collecting, by a processor, symptom data from the patient via the electronic diagnostic device; analyzing, by the processor, the symptom data; diagnosing, by the processor, a disorder of the patient as a function of the symptom data; retrieving, by the processor, an insurance cost schedule for each healthcare provider accessible to the patient; calculating, by the processor, a cost for treating the disorder as a function of the insurance cost schedule for each healthcare provider accessible to the patient; transmitting, by the processor, the cost and an availability schedule of each healthcare provider to the patient; receiving, by the processor, user input selecting a healthcare provider from the availability schedule; and scheduling, by the processor, treatment with the healthcare provider as a function of the user input.

A third embodiment of the present disclosure provides a computer program product comprising: one or more computer readable hardware storage devices having computer readable program code stored therein, said program code containing instructions executable by one or more processors to implement a method for estimating health care costs of a patient comprising the steps of: collecting, by a processor, symptom data from the patient; analyzing, by the processor, the symptom data; diagnosing, by the processor, a disorder of the patient as a function of the symptom data; retrieving, by the processor, an insurance cost schedule for each healthcare provider accessible to the patient; calculating, by the processor, a cost for treating the disorder as a function of the insurance cost schedule for each healthcare provider accessible to the patient; transmitting, by the processor, the cost and an availability schedule of each healthcare provider to the patient; receiving, by the processor, user input selecting a healthcare provider from the availability schedule; and scheduling, by the processor, treatment with the healthcare provider as a function of the user input.

### BRIEF DESCRIPTION OF THE DRAWINGS

FIG. 1 depicts a block diagram of an embodiment of a computerized system for estimating health care costs of a patient.

FIG. 2 depicts a flow chart of an embodiment of a computerized system for estimating health care costs of a patient.

FIG. 3 depicts an embodiment of an algorithm for estimating healthcare costs of a patient.

FIG. 4 depicts a block diagram of an embodiment of a generic computer system capable of implementing methods for estimating healthcare costs of a patient consistent with the embodiments described in this application.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

### Overview

One of the biggest challenges for selecting healthcare and controlling healthcare costs is the inability to compare costs between providers. Even if a patient is aware of the disorder or disease affecting the patient's body, receiving an estimate for healthcare costs ahead of receiving treatment, or at the very least a diagnosis from a licensed professional, can be time-prohibitive. Very few (if any) medical practices provide cost estimates for administering treatment of diseases and disorders ahead of time. The lack of healthcare cost estimates usually can arise due in part to the differences in insurance carriers and a lack of insurance data that is not readily available for making an assessment of the estimated cost. There is currently a need for patients to receive a cost estimate for the patient's most probable diagnosis before scheduling the recommended treatment. Receiving a cost estimate before scheduling treatment allows for patients to weigh each of the patient's healthcare options that may be available, assess the patient's share of the cost burden and select a healthcare provider that may offer the most cost-efficient treatment.

Embodiments of present disclosure innovate and improve upon the limited or currently unavailable healthcare cost estimation systems, methods and tools. The embodiments of the present disclosure leverage computer networking resources, machine learning technologies and artificial intelligence systems to predicts diagnoses, estimate costs associated with treating the diagnoses and allow patients to remotely schedule treatment with healthcare providers, based on the estimated costs provided.

In some embodiments of the disclosure, a potential patient may access a cost comparison portal using a client computing device to remotely access a cost scheduling system. The patient may input relevant user information into the cost scheduling system via the portal, including the user's name, age, birthday, insurance provider, insurance plan, medical history, previous physicians and preferred physicians, etc. A patient may further input known symptom information into the cost scheduling system to receive a potential diagnosis. Symptom data may be derived from the patient's input into the client device. In some embodiments, medical instruments capable of measuring physiological data may be electronically coupled to the patient's client computing device or a remotely accessible computing network hosting the cost scheduling system. The symptom data may be collected by the cost scheduling system, analyzed using data analytics, analytic models, machine learning or IBM's Watson computing technology to predict the patient's disorder or disease.

In some instances of the disclosure, the embodiments of the cost scheduling system may retrieve cost schedules comprising estimated healthcare costs for treating the diagnosed disorder or disease from each healthcare provider available to the patient. The patient's client device may receive a report generated by the cost scheduling system describing each healthcare provider's expected costs for administering treatment based on the anticipated diagnosis. A patient, receiving the health care cost estimates from each provider may use the patient's client device to select the desired health care provider according to the patient's healthcare needs and budget. Subsequently, a patient may further receive scheduling data from the selected healthcare provider. A patient may remotely schedule a date and time to meet with the healthcare provider, receive a confirmation of the projected diagnosis provided by the cost scheduling system and may further commence treatment in accordance with the confirmation of the diagnosis.

### System for Estimating Health Care Costs

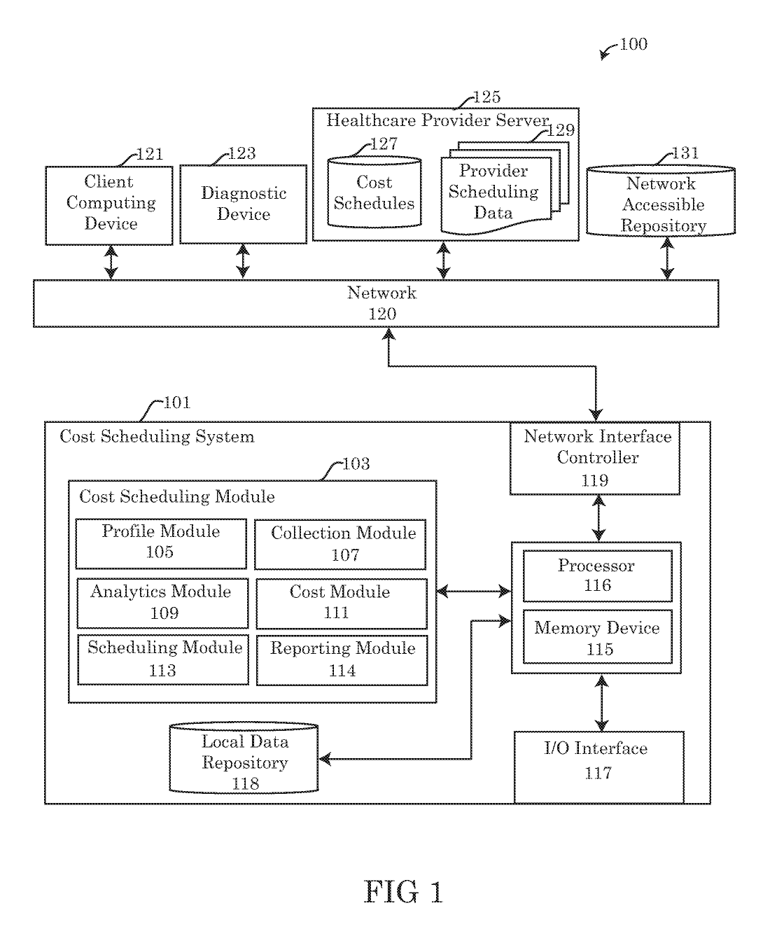

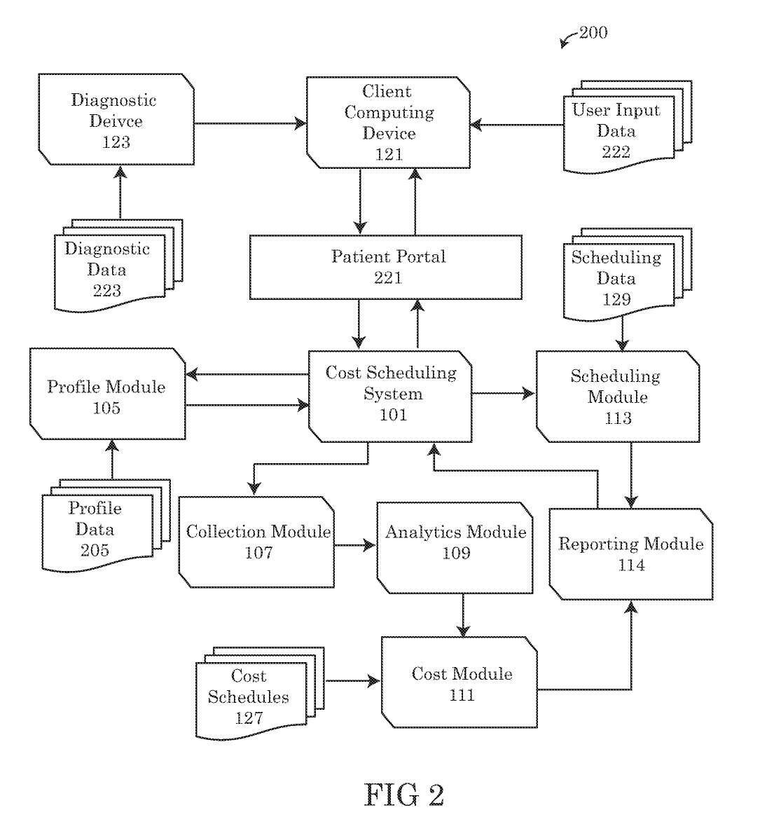

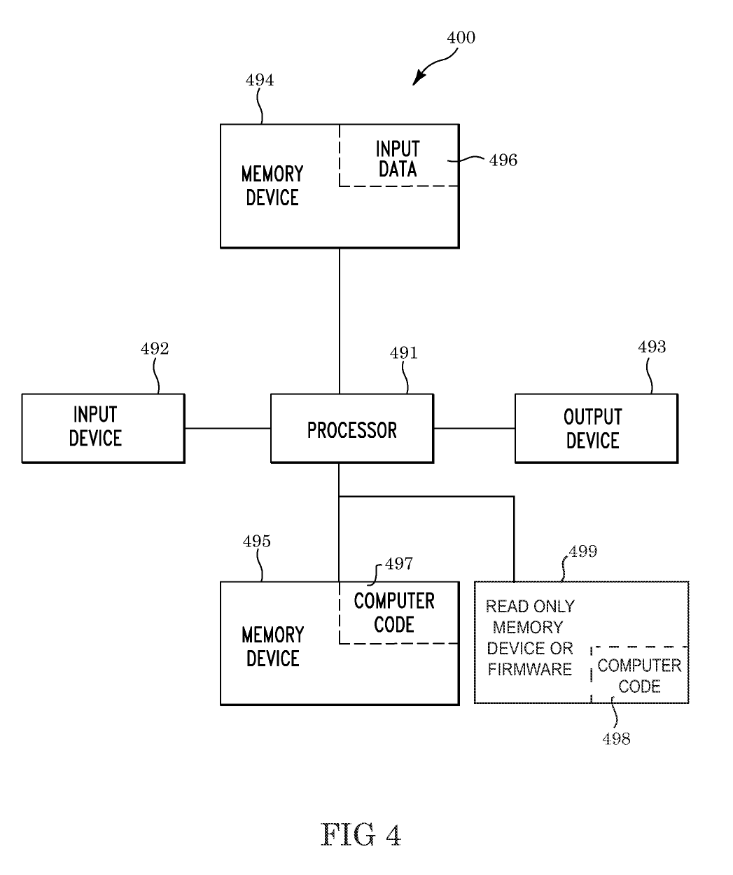

Referring to the drawings, FIG. 1 illustrates a diagram of an embodiment of a system 100 for estimating healthcare costs of a patient and subsequently scheduling treatment with a healthcare provider based on the estimated healthcare costs. Embodiments of system 100 may comprise specialized computer systems 101, 121, 123, 125 having a specialized configuration of hardware, software or a combination thereof as depicted in FIGS. 1-2 and as described throughout the present disclosure. Embodiments of the computer systems 101, 121, 123, 125 may further comprise one or more elements of the generic computer system 400 of FIG. 4, described in detail below. The elements of the generic computer system 400 may be integrated into each of the specialized computer systems 101, 121, 123, 125 described herein.

Each of the computer systems 101, 121, 123, 125 may each be connected and placed in communication with one another over a computer network 120. Embodiments of the network 120 may be constructed using wired or wireless connections between each hardware component connected to the network 120. As shown in the exemplary embodiments, each of the computer systems 101, 121, 123, 125 may connect to the network 120 and communicate over the network 120 using a network interface controller (NIC) 119 or other network communication hardware. Embodiments of the NIC 119 may implement specialized electronic circuitry allowing for communication between computer systems 101, 121, 123, 125 and the network 120 using a specific physical layer and a data link layer standard such as Ethernet, Fiber channel, Wi-Fi or Token Ring.

The NIC 119 may further allow for a full network protocol stack, enabling communication over network 120 to the group of computer systems 101, 121, 123, 125 or other computing hardware devices linked together through communication channels, such as a network accessible data repository 131, or other data sources accessible over the network 120. The network 120 may facilitate communication and resource sharing among the computer systems 101, 121, 123, 125 and additional hardware devices connected to the network 120. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Embodiments of the healthcare cost estimation and scheduling system 100 may include a specialized computer referred to herein as a cost scheduling system 101. The cost scheduling system 101 may include a processor 116 (such as a central processing unit), specialized hardware or circuitry and/or software loaded in the memory device 115 of the cost scheduling system 101. The embodiments of the cost scheduling system 101 may perform functions, tasks and routines relating to saving, storing and loading patient profile information, collecting or aggregating symptom data from patients, analyzing the symptom data to generate a diagnosis of a patient, query healthcare providers for healthcare costs and schedule patient treatment as the function of the patient's selected healthcare provider.

Embodiments of the specialized hardware and/or software integrated into the cost scheduling system 101 may be part of a cost scheduling module 103. The hardware and/or software components of the cost scheduling module 103 may include a profile module 105, collection module 107, analytics module 109, cost module 111, scheduling module 113 and reporting module 114. As used herein, the term “module” may refer to a hardware module, software-based module or a module may be a combination of hardware and software resources of the cost scheduling system 101 and/or resources remotely accessible to the cost scheduling system via a computer network 120. Embodiments of the modules described in this application, whether comprising hardware, software or a combination of resources thereof, may be designed to implement or execute one or more particular functions, tasks or routines of the cost scheduling system 101. Embodiments of hardware-based modules may include self-contained components such as chipsets, specialized circuitry and one or more memory devices comprising a memory storage medium (described below).

A software-based module may be part of a program code or linked to program code or computer code 497, 498 containing specific programmed instructions loaded into the memory device 115 of the respective cost scheduling system, and/or a remotely accessible memory device 115 of a network accessible computer system 121, 123, 125. For example, in some embodiments the network accessible computer system may be a server 125, client computing device 121 medical diagnostic devices 123 or network accessible hardware, such as a network accessible storage devices such as the network accessible repository 131.

In some embodiments of the cost scheduling system 101, the cost scheduling module 103 may include one or more sub-modules that may be assigned to perform one or more particular tasks and functions of the cost scheduling system 101. The types and number of sub-modules may vary from embodiment to embodiment depending on the components and arrangement of components featured in each of the systems 100, 200. However, in the exemplary embodiments shown in FIGS. 1-2, the cost scheduling system 101 may comprise a profile module 105, collection module 107, analytics module 109, cost module 111, scheduling module 113 and a reporting module 114.

Embodiments of the profile module 105 may perform the task and function of creating, saving, storing and loading user profiles accessed by each patient communicating with the cost scheduling system 101 over network 120. The profiles created by each patient may store patient specific information that may be accessed remotely by the patient from a client computing device 121 or by a healthcare provider having access to the healthcare provider server 125. Embodiments of the patient's profile may include information such as the patient's name, address, age, date of birth, billing and/or mailing address, healthcare provide (i.e. physician), known medical conditions/allergies, insurance provider, emergency contacts, relatives and any other information generally provided by patients to a healthcare provider.

A patient logging in to the patient's profile may, in some embodiments, may do so through a patient portal 221 using a client computing device 121. A “client computing device” may refer to a piece of computer hardware or software that may access a service made available by a server. The client computer device 121 may send requests to through the patient portal 221 to the cost scheduling system 101 which may be acting as a server in some embodiments to deliver the requested content back to the patient's client computing device 121. The cost scheduling system 101 may act as a web server or application server, receiving a connection from the client computer device 121 which may be connecting to the cost scheduling system remotely over network 120 using a thin client, such as a web browser to access the patient portal. Alternatively, in some embodiments, a separate web server or application server may be sending and receiving requests from both the client computer device 121 operated by the patient and the cost scheduling system.

In the exemplary embodiment, the profile module 105 may securely store patient profiles and transmit profile information to the patient's client device (or intermediary server) when authorized to do so. To access the patient's profile in some embodiments, the patient may authenticate credentials or receive permission to access the profile stored locally or remotely by the cost scheduling system 101. For example, the patient may provide a user name and corresponding password, biometric data or a security smart card. In some embodiments, the patient's credentials to access the profile maintained by the profile module 105, may be stored on a patient's medical ID card or insurance card. In such an embodiment, the client computing device 121 or the cost scheduling system may be equipped with a scanning device or card reader capable of decoding the patient's profile data from the medical ID card or insurance card. Once authentication of the patient is verified, the profile module 105 may load the patient profile into the memory device 115 of the cost scheduling system 101. The profile module may further transmit the patient's profile data to the client computer device 121, wherein the patient profile may be loaded into a memory device or computer storage device of the client computer device 121.

In some embodiments of the cost scheduling system 101, the cost scheduling module 103 may comprise a collection module 107. Embodiments of the collection module 107 may perform the function of receiving, retrieving and/or aggregating a patient's medical symptoms as symptom data. The symptom data collected by the collection module 107 may be provided from a plurality of data sources. A patient may directly transmit descriptions of symptoms over network 120 by entering the descriptions of the patient's symptoms into the client computer device 121. For example, the cost scheduling system 101 or an intermediary server may transmit electronic forms, checklists, surveys through the network 120 to the client computing device 121 for the patient to fill in and describe the patient's condition and symptoms. A patient may select the symptoms that apply to the patient's condition or freely write out details of the patient's symptoms and transmit the symptom data back to the cost scheduling system 101. The collection module 107 may aggregate the electronically transmitted symptom data and correlate the symptoms to the patient profile loaded in the memory device 115 of the cost scheduling system 101.

In addition to the patient providing descriptions or electronic forms describing the patient's condition, in some embodiments, the patient may take physiological measurements using a diagnostic device 123, and then subsequently transmit the physiological measurements as physiological data to the collection module 107. Physiological data measured and transmitted by the diagnostic device 123 may include measurements of a patient's heart rate, blood pressure, temperature, blood glucose level, pulse, muscle tension, neuronal activity, insulin resistance, blood oxygen saturation levels (SPO₂), and any other types of physiological data that may be collected from a diagnostic device 123 known by a person skilled in the art.

In some embodiments, the patient may access a diagnostic device 123, for example a thermometer, blood pressure cuff, stethoscope, pulse oximeter, heart rate monitor, EEG, blood glucose measuring device, etc. to perform the measurements of the physiological data. In alternative embodiments, the patient may simply wear medical monitoring device that collects physiological data from the patient whenever the device is accessible. For instance a fitness tracking device such as a FitBit™, Jawbone® UP3, Moov Now™, etc. Embodiments of diagnostic device 123 may be electronically coupled to the client computing device 121 in some embodiments through an input/output interface. In alternative embodiments, the diagnostic device 123 may wirelessly transmit collected symptom data to over a network 120 to either the client computing device 121 or the cost scheduling system 101. For example, the diagnostic device may interface wirelessly with either the client computing device 121 or cost scheduling system using a wireless data protocol such as Wi-Fi, Bluetooth, Bluetooth LE, infrared, ZigBee, WiMax, microwaves, radio waves, cellular transmission, etc.

In some embodiments, the patient may not directly send the symptom data collected by the diagnostic device 123 to the collection module 107. Instead, the diagnostic device 123 may transmit the physiological data over network 120 to the cost scheduling system 101 where the data may be stored by the collection module 107. In alternative embodiments, the cost scheduling system 101 may retrieve the physiological data stored by the diagnostic device 123 by connecting to the diagnostic device 123 over network 120 and downloading the physiological data stored by the diagnostic device 123. For example, a patient may connect a fitness tracking device to the network 120 and providing permission to the cost scheduling system 101 to access the patient's fitness tracking device. The collection module 107 may periodically sync with the diagnostic device 123 (in this example, the fitness tracker) and store physiological data in the patient's profile. By periodically syncing and downloading the patient's physiological data, the cost scheduling system has a history of the patient's physiological data to compare the patient's current symptoms with the physiological data collected at the time a disease or disorder is being self-identified by the patient.

In some embodiments of the healthcare management system 100, the cost scheduling system 101 may be capable of diagnosing a patient's disease or disorder as a function of the symptom data and physiological data provided by the patient and/or the diagnostic devices 123 collecting the physiological data. To render a diagnosis of a probable disease, based on the collected symptom data and physiologic data, the cost scheduling system 101 may include an analytics module 109. Embodiments of the analytics module 109 may perform the function or task of rendering a diagnosis of the patient using quantitative and qualitative data analytics to examine data sets in order to uncover hidden patterns, unknown correlations and predictions directed toward the patient's disease and disorder. The analytics module 109 may use data analytics and machine learning to reach the most probable diagnoses of the patient. The term data analytics may refer to the process of examining the data sets in order to interpret, draw conclusions and communicate meaningful patterns in the data collected by the collection module 107.

Embodiments of the analytics module 109 may use specialized tools that perform functions such as predictive analytics, data mining, text analytics and statistical analysis to draw conclusions about a patient's health, diseases and disorders. In some cases, the analytics module 109 may take advantage of Hadoop clusters and NoSQL systems as a staging area for the data before the data is loaded into a data warehouse or central repository 118, 131 for analysis. In some alternative embodiments, the analytics module 109 may take advantage of data visualization and IBM's Watson analytics to diagnose the patient based on the data provided to the collection module 107.

In some embodiments, the analytics module 109 may not only use analytics to drive the diagnosis of the patient, but also machine learning. The analytics module 109 may access data sources via network 120 that list disease symptoms and confirmed diagnoses of other patients. The analytics module 109 may retrieve lists and data sets of symptoms as well as the corresponding diseases from one or more data sources and build a knowledge base of diseases, disorders and the accompanying symptoms corresponding thereto. Embodiments of the analytics module 109 may compare the descriptions of the user input data 222 provided as symptom data to the collection module as well as the physiological diagnostic data 223 provided by the diagnostic device 123 with the knowledge base of known diseases, disorders and symptoms. The analytics module 109 may draw conclusions and assign probabilities to one or more diseases or disorders and report the most probable diagnoses to the patient.

In some embodiments, the collection module 107 may receive and collect opinions and analysis of third party medical professionals capable of accessing the cost scheduling system 101. In some embodiments, the operator or administrator of the cost scheduling system 101 may hire or grant access to medical professionals for the purpose of examining patient symptoms and offering the medical professional's expert opinion which may be inputted as data into the collection module 107. Whereas in alternative embodiments, the collection module 107 may retrieve analysis data from medical professionals who may have previously analyzed the patient or patients exhibiting similar symptoms. The opinions of the medical professionals may be provided to the analytics module 109, which may increase the accuracy of the analytics module's 109 diagnosis of the patient.

Embodiments of the cost scheduling system 101 may, in some embodiments include a cost module 111. The cost module 111 may perform the function or task of retrieving, storing and presenting cost information to the patient. The cost module 107 may retrieve and/or download cost schedules 127 for each healthcare provider available to the patient. In some embodiments, the cost schedule may be in the form of a cost table or other data structure. The cost module 111 may remotely access and retrieve each cost schedule 127 stored by one or more healthcare provider server 125. The cost module 111 may transmit a request over the network 120 to the healthcare provider server 125 requesting the cost schedules 127. The healthcare provider server 125 may transmit back to the cost module 111 a cost schedule 127 comprising estimated costs for treating the most probable diagnoses drawn by the analytics module 109 in some embodiments. In other embodiments, the healthcare provider server 125 may transmit cost schedules 127 for each of the healthcare related services provided to patients. The cost module 111 may, in some embodiments parse the cost schedules 127 for estimated costs relating to the diagnoses drawn by the analytics module 109. Alternatively, the analytics module 109 may receive the cost schedules from the cost module 111 and parse the cost schedules 127 by querying the cost schedules for diagnoses related services.

In some embodiments, the cost module 111 may organize the costs schedules 127 received from each healthcare provider server 125 and aggregate each of the estimated costs of the healthcare providers into a format that may be easier for the client to read and understand. For example, the cost module 111 may organize each healthcare provider's cost schedule 127 into a data table that clearly shows to the patient the healthcare provider and the estimates costs for treating the most probable diagnoses projected by the analytics module 109. In some embodiments, the cost module 111 may not only present the treatment costs associated with each particular healthcare provider. The cost module 111 may further retrieve secondary information about each healthcare provider and further insert the secondary information into the data table of estimated healthcare costs.

For example, the cost module may query and retrieve reviews of the healthcare provider from one or more data sources, data about the quality of treatment from healthcare providers, statistics on cost increases over time, statistics on a patient's insurance company paying the healthcare provider fees etc. In some embodiments, the cost module 111 may further retrieve incentives and discounts offered by the insurance company used by the patient. A patient's insurer may have a preferred healthcare provider that the insurance company prefers to work with over others. The cost module 111 may identify cost reduction incentives, coupons and discounts offered by the insurance company for the patient choosing to use a particular healthcare provider. These incentives and discounts from the insurance company may be applied to the cost of the healthcare provider's treatment in the data table presented to the patient, or the discount may be added as secondary information into the table to further assist the patient with making a decision on the appropriate healthcare provider, based on the patients' needs and budget.

Embodiments of the cost scheduling module 103 may further comprise a scheduling module 113. The scheduling module 113 may perform the task or function of retrieving scheduling data 129 from each healthcare provider, presenting the available scheduling options to the patient and scheduling healthcare services with the healthcare provider as a function of the patient's input. Based on the patient's user input to the cost module 111, wherein the patient has selected the healthcare provider based on the costs schedules 127 presented to the patient, the patient's healthcare provider selection may be transmitted to the scheduling module 113. The scheduling module, may, as a function of the patient's healthcare provider selection, query the healthcare provider server 125 for the selected health care provider's scheduling data 129.

Embodiments of the scheduling module may transmit the query for the provider's scheduling data over network 120. Upon receipt of the scheduling data 129 request, the scheduling module may retrieve the healthcare provider's scheduling data and present the selected provider's availability for administering healthcare services to the patient. For example, the scheduling data may identify available time slots that a patient may reserve for receiving healthcare treatment. The scheduling module 113 may transmit the scheduling data 129 retrieved from the healthcare provider server to the patient. For instance, the scheduling module 113 may transmit the scheduling data to the client computing device 121 being operated by the patient. Using the scheduling data 129, the patient may view the availability of the healthcare provider to provide healthcare services. Accordingly, the patient, via the patient's input data 222 may select a desired time and date for receiving the healthcare services of the healthcare provider.

In some embodiments, the scheduling module may receive the patient's input data 222 selecting a particular date and time for scheduling healthcare services with the healthcare provider. Embodiments of the scheduling module may save the patient's preferred scheduling preferences and transmit the preference of the patient to the healthcare provider's server 125. The scheduling module may request the healthcare provider server to schedule an appointment with the patient as the selected date and time. In some embodiments, the scheduling module 113 may further transmit the patient's profile information to the healthcare provider's server, allowing for the healthcare provider to receive patient information that may have been collected by the profile module 105, as well as the proposed diagnosis of the cost scheduling system 101, prior to the patient arriving for the receipt of healthcare service from the healthcare provider.

In some embodiments of the cost scheduling module 103 the cost scheduling system 101 may further comprise a reporting module 114. The reporting module 114 may be responsible for reporting and transmitting output from the cost scheduling system 101 to one or more computer systems 101, 121, 123, 125 in a computer readable format that a user may understand. The reporting module 114 may be responsible for presenting and transmitting information in the computer readable format to the client computing device 121, including the transmission of patient's profile information, the diagnosis of the patient as determined by the analytics module 109, the estimated costs 127 calculated by the cost module 111, and the available scheduling data 129 of the healthcare provider.

Referring to the drawings, FIG. 2 depicts a flowchart of an embodiment 200 of the healthcare estimation system 100 describing the flow of data between each of the elements comprising the healthcare estimation system. As shown in the system 200 the client computing device 121, which may be operated by the patient, may connect to a patient portal 221 via network 120. Embodiments of the patient portal 221 may be a gateway that allows the patient to access and interface with the cost scheduling system 101. For example, the patient portal 221 may be a website, application or service.

Upon accessing the cost scheduling system 101 via the patient portal 221, the patient may direct the cost scheduling system 101 to retrieve the patient's profile from the profile module 105. The profile module 105 may load profile data 205 into the profile module 105 and/or the memory device 115 of the cost scheduling system 101. The profile data 205 may be transmitted and loaded onto the client computer system 121. The client computing system 121 may display the patient's profile information on a display device connected to the client computing device 121. Moreover, the cost scheduling system 101 in some embodiments, may direct the patient to provide symptom data for the purposes of diagnosing the patient and estimating healthcare costs based on the diagnosis. Symptom data may be provided from a plethora of data sources. These data sources may include medical information accessible to the cost scheduling system, patient input data 222 which may be entered directly into the client computing device 121 by the patient and diagnostic data 223 measured by diagnostic device 123.

Embodiments of the client computing device 121, as shown in the embodiment 200 of FIG. 2, may transmit the symptom data comprising diagnostic data 223 and/or the patient input data 222 over the network 120 through the patient portal 221 to the cost scheduling system 101. The received symptom data may be collected and aggregated by the collection module 107 of the cost scheduling system 101. As the collection module 107 collects symptom data from the patient, diagnostic devices 123 and network accessible data sources, the symptom data may be transmitted, streamed or retrieved by the analytics module 109 or staged at a data repository 118, 131 accessible to the analytics module. The analytics module 109 may perform statistical analytics, data analytics and/or use machine learning to identify patterns in the symptom data and compare the symptom data to known diseases and disorders in order to identify the most probable diseases and disorders to treat the patient.

The conclusions promulgated by the analytics module 109 may be reported to the cost module 111, which may be responsible for obtaining and estimating the costs for treating the most probable disease identified by the conclusions of the analytics module 109. The cost module 111 may request and/or retrieve the cost schedules from each of the available health providers able to provide health services to the patient. Embodiments of the cost module 111 may remotely access each health care provider server 125 and receive one or more cost schedules estimating the cost for treating the most probable disease concluded, by the analytics module 109 to be the most likely ailments suffered by the patient. The cost module may save and store the cost schedules 127 in the memory device 115 of the cost scheduling system, local repository 118 and/or the network accessible repository 131. The cost module 111 may further format each of the cost schedules 127 received from each healthcare provider and any additional secondary information. The cost module 111 may generate a cost estimate report describing the estimated costs for treating the patients most probable diseases or disorders and transmit the cost estimate report via the reporting module 114 to the patient's client computing device 121.

Upon receiving the cost estimate report from the cost scheduling system 101, the patient may provide the patient's input data 222 indicating the patient's preference for selecting a healthcare provider. The patient's selection of a healthcare provider may be transmitted over the patient portal 221 via network 120 back to the cost scheduling system 101. Based on the patient's input data 222 indicating the patient's selection of a healthcare provider, the cost scheduling system 101 may update the patient's profile and query via the scheduling module 113, the scheduling data of the selected healthcare provider. The scheduling data 129 may be retrieved from the selected healthcare provider's server 125 and further transmitted back to the client computing device 121.

The scheduling data 129 may identify dates and times that the healthcare provider may schedule a treatment session with the patient to treat the disease or disorder. The patient may schedule the treatment appointment by providing input data 222 to the cost scheduling system 101, indicating the preferred appointment date, time, location, etc. The scheduling module 113 may subsequently request the healthcare provider server 125 to schedule the patient for treatment with the healthcare provider at the appointment date, time and location selected by the patient.

### Method for Estimating Health Care Costs

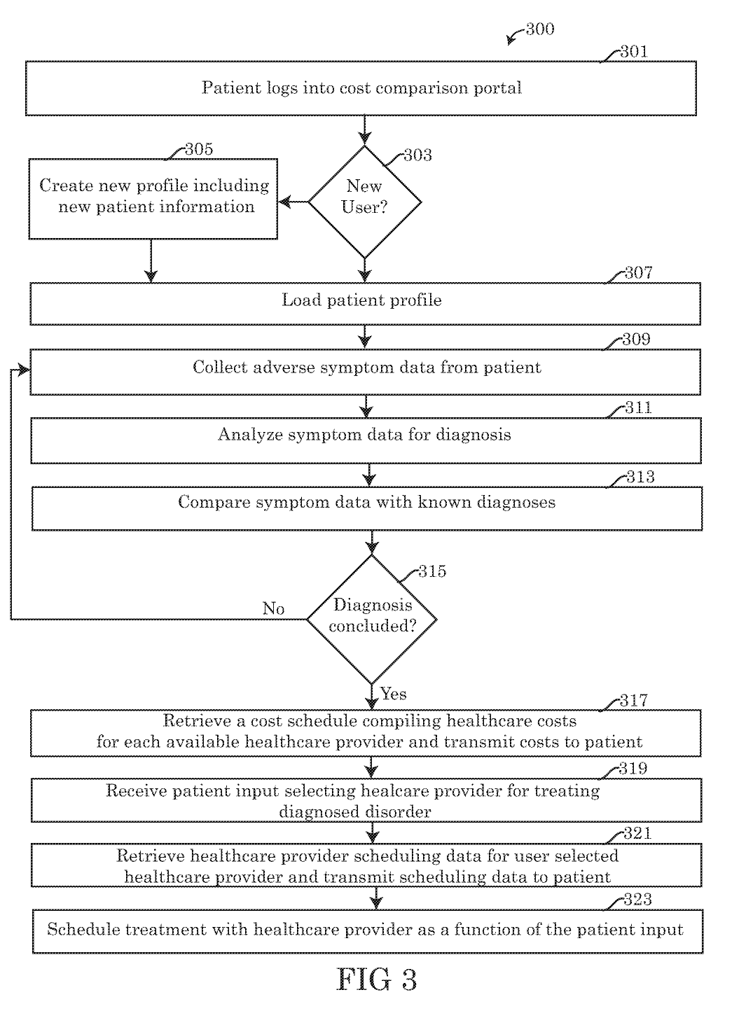

The drawing of FIG. 3 represents an embodiment 300 of an algorithm that may be implemented for estimating health care costs in accordance with the systems described in FIGS. 1-2 using one or more computer systems defined generically in FIG. 4 below, and more specifically by the specific embodiments described herein. A person skilled in the art should recognize that the steps of the algorithm described in FIG. 3 may not require all of the steps disclosed herein to be performed, nor does the algorithm of FIG. 3 necessarily require that all the steps be performed in the particular order presented. Variations of the algorithm steps presented in FIG. 3 may be performed, wherein one or more steps may be performed in a different order than presented by FIG. 3.

The algorithm 300, described in FIG. 3, may initiate in step 301 by a patient accessing a patient portal 221 acting as a gateway between the patient's client computing device 121 and the cost scheduling system 101. The patient's client computing device may access the patient portal 221 through an application or service such as a healthcare application or even by accessing the patient portal using a thin client such as a web browser to navigate to the patient portal's 221 website. Upon access the patient portal in step 301, the algorithm may proceed to step 303, wherein the cost scheduling system 101 may make a determination whether or not the patient is a new user or a returning user.

If, in step 303, the patient is a returning user or the patient has a profile accessible to the cost scheduling system 101, the patient may provide permissions or authenticating data to demonstrate that the patient has been authorized to access the patient's profile. Accordingly, upon authentication of the patient's credentials, the algorithm may proceed to step 307 and load via the profile module 105, the patient's profile into the memory device 115 of the cost scheduling system 101. Conversely, if the algorithm 300 determines that the patient is a new user of the cost scheduling system 101, and the patient does not yet have a profile accessible to the cost scheduling system 101, the algorithm 300 may proceed to step 305 in order to create a new patient profile.

In step 305, the new patient may create a new profile by providing patient input data 222 into the patient's client computing device 121. The patient's information provided may include medically relevant information such as the patient's name, age, address, birth date, medical history, physician, insurance carrier, insurance plan, etc. The patient's input data 222 may be collected, saved and stored by the profile module 105, either locally in the cost scheduling system's 101 local repository 118 or remotely stored in one or more network accessible repositories 131. Once the new profile has been created in step 305, the profile module 105 may load the patient's profile in step 307. The patient profile may be loaded into the memory device 115 of the cost scheduling system 101 and in some embodiments, the profile data may be transmitted over network 120 and displayed by the patient's client computing device 121.

In step 309 of the algorithm 300, the collection module 107 may collect symptom data from the patient and aggregate the collected data to a computer storage device, data repository 118, 131 or memory device 115. The symptom data may comprise patient input data 222 provided by the patient, wherein the patient may directly describe the types of symptoms the patient is experiencing or selecting one or more symptoms from a list generated by the cost scheduling system 101 and displayed by the client computing device 121. In some embodiments, the symptom data may further include diagnostic data 223 collected by a diagnostic device 123 which may be placed into electronic communication or network communication with the cost comparison scheduling system 101. The diagnostic data 223 may include physiological measurements calculated by the diagnostic device 123. Examples of the diagnostic devices 123 may include fitness tracking devices, heart rate monitors, blood pressure cuffs, thermometers, glucose meters, muscle contraction sensor, electroencephalography (EEG) or pulse oximeter.

The diagnostic devices 123 may collect physiological measurements and present the measurements as diagnostic data such as the patient's heart rate, blood pressure, temperature, blood glucose level, pulse, muscle tension, neuronal activity, insulin resistance, blood oxygen saturation levels (SPO₂). Embodiments of the diagnostic device 123 may transmit the diagnostic data 223 over network 120 to the collection module 107 of the cost scheduling system 101. Alternatively, the diagnostic device 123 may be placed into electronic communication with the patient's client computing device 121. The diagnostic device 123 may transfer the diagnostic data to the client computing device 121 initially and the diagnostic data 223 may be subsequently transmitted by the client computing device 121 to the cost scheduling system 101.

In step 311 of the algorithm 300, the symptom data being collected by the collection module 107 may be analyzed by the analytics module 109 for a diagnosis. The analytics module 109 may receive each piece of symptom data and apply an analytical model, draw conclusions and inferences from the symptom data to calculate a probability of the most likely diagnoses of the patient's disease or disorder. In some embodiments, the analytics module 109 may, in step 313 consult a knowledge base of known diseases, each having a known array of symptoms. In step 313, the analytics module 109 may compare the symptom data with known disease diagnoses and draw conclusions based on the similarities between the patient's symptoms and the closes diseases or disorders of the knowledge base.

The algorithm 300, in step 315 may determine whether or not a diagnosis has been reached by the analytics module 109. If, a diagnosis has not been reached by the analytics module 109, algorithm may return to step 309 as described above, allowing for the collection module 107 to continue collecting additional symptom data that may assist the analytics module 109 with drawing better conclusions or inferences about the patient's disease or disorder. Conversely, if in step 315, it is determined by the analytics module 109 that one or more particular diseases are the likely diagnosis of the patient, the algorithm may proceed to step 317 to determine the costs of treating the diagnosed disease.

In step 317 of algorithm 300, the cost scheduling system 101 may retrieve cost schedules 127 compiling the healthcare costs for treating the patient's most probable disease or disorder diagnosed by the analytics module 109. The cost module 111 of the cost scheduling system 101 may request the cost schedules 127 from each potential healthcare provider available to the patient. In some embodiments, the cost module 111 may compile the costs for treating the diagnosis by retrieving the cost schedules 127 from each healthcare provider's server 125. Once retrieved from each healthcare provider server 125, the cost module 111 may format and aggregate the cost schedule data 127 for presentation to the patient. Subsequently, once aggregated, the cost module 111 may transmit the health care cost schedules, and any additional secondary information that may be useful to the patient for each provider, to the patient.

In step 319, the patient may make a selection of the desired healthcare provider as a function of the cost schedules and any secondary information that may be provided to the patient. The patient may, use the client computing device 121 to communicate to the cost scheduling system 101 via the patient's input into the client computing device 121, the desired healthcare provider the patient desires to have treat the diagnosed disease or disorder. As a function of the patient's input designating the desired healthcare provider, the scheduling module 113 of the cost scheduling system 101 may further retrieve the selected healthcare provider's scheduling data 129 from the healthcare provider's server 125. The scheduling module 113 may transmit the retrieved scheduling data 129 to the patient's client computing device 121 for further input from the patient regarding the scheduling of an appointment to treat or further diagnose the patient's condition.

In step 323, the cost scheduling system 101 may receive the patient's input selecting a desire date, time and/or appointment for receiving scheduled treatment from the healthcare provider selected in step 319. The scheduling module 113 may proceed to schedule the desired appointment with the selected healthcare provider. For example, the scheduling module 113 may connect to the healthcare provider's server and schedule the appointment with the healthcare provider on behalf of the patient. Completing the cost estimating and scheduling process. Accordingly, the patient may proceed to reschedule a selected appointment by reconnecting to the cost scheduling system 101 via the patient portal 221 and amending the previously scheduled time for a new appointment based on the current availability of the healthcare provider.

### Computer System

Referring to the drawings, FIG. 4 illustrates a block diagram of a computer system 400 that may be included in the systems of FIGS. 1-2 and for implementing methods for estimating health care costs of a patient of FIG. 3 and in accordance with the embodiments described in the present disclosure. The computer system 400 may generally comprise a processor 491, otherwise referred to as a central processing unit (CPU), an input device 492 coupled to the processor 491, an output device 493 coupled to the processor 491, and memory devices 494 and 495 each coupled to the processor 491. The input device 492, output device 493 and memory devices 494, 495 may each be coupled to the processor 491 via a bus. Processor 491 may perform computations and control the functions of computer 400, including executing instructions included in the computer code 497 for tools and programs for estimating health care costs of a patient, in the manner prescribed by the embodiments of the disclosure using the systems of FIGS. 1-2, wherein the instructions of the computer code 497 may be executed by processor 491 via memory device 495. The computer code 497 may include software or program instructions that may implement one or more algorithms for estimating health care costs of a patient, as described in detail above. The processor 491 executes the computer code 497. Processor 491 may include a single processing unit, or may be distributed across one or more processing units in one or more locations (e.g., on a client and server).

The memory device 494 may include input data 496. The input data 496 includes any inputs required by the computer code 497, 498. The output device 493 displays output from the computer code 497, 498. Either or both memory devices 494 and 495 may be used as a computer usable storage medium (or program storage device) having a computer readable program embodied therein and/or having other data stored therein, wherein the computer readable program comprises the computer code 497, 498. Generally, a computer program product (or, alternatively, an article of manufacture) of the computer system 400 may comprise said computer usable storage medium (or said program storage device).

Memory devices 494, 495 include any known computer readable storage medium, including those described in detail below. In one embodiment, cache memory elements of memory devices 494, 495 may provide temporary storage of at least some program code (e.g., computer code 497, 498) in order to reduce the number of times code must be retrieved from bulk storage while instructions of the computer code 497, 498 are executed. Moreover, similar to processor 491, memory devices 494, 495 may reside at a single physical location, including one or more types of data storage, or be distributed across a plurality of physical systems in various forms. Further, memory devices 494, 495 can include data distributed across, for example, a local area network (LAN) or a wide area network (WAN). Further, memory devices 494, 495 may include an operating system (not shown) and may include other systems not shown in the figures.

In some embodiments, rather than being stored and accessed from a hard drive, optical disc or other writeable, rewriteable, or removable hardware memory device 494, 495, stored computer program code 498 (e.g., including algorithms) may be stored on a static, non-removable, read-only storage medium such as a Read-Only Memory (ROM) device 499, or may be accessed by processor 491 directly from such a static, non-removable, read-only medium 499. Similarly, in some embodiments, stored computer program code 497 may be stored as computer-readable firmware 499, or may be accessed by processor 491 directly from such firmware 499, rather than from a more dynamic or removable hardware data-storage device 495, such as a hard drive or optical disc.

In some embodiments, the computer system 400 may further be coupled to an Input/output (I/O) interface and a computer data storage unit (for example a data store, data mart or repository). An I/O interface may include any system for exchanging information to or from an input device 492 or output device 493. The input device 492 may be, inter alia, a keyboard, joystick, trackball, touchpad, mouse, sensors, beacons, RFID tags, microphones, biometric input device, camera, timer, etc. The output device 493 may be, inter alia, a printer, a plotter, a display device (such as a computer screen or monitor), a magnetic tape, a removable hard disk, a floppy disk, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 400, and may include any type of transmission link, including electrical, optical, wireless, etc.

The I/O interface may allow computer system 400 to store information (e.g., data or program instructions such as program code 497, 498) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider able to deploy or integrate computing infrastructure with respect to estimating health care costs of a patient. Thus, an embodiment of the present invention discloses a process for supporting computer infrastructure, where the process includes providing at least one support service for at least one of integrating, hosting, maintaining and deploying computer-readable code (e.g., program code 497, 498) in a computer system (e.g., computer 400) including one or more processor(s) 491, wherein the processor(s) carry out instructions contained in the computer code 497 causing the computer system to estimate health care costs of a patient. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for estimating health care costs of a patient. Thus the present invention discloses a process for supporting, deploying and/or integrating computer infrastructure, integrating, hosting, maintaining, and deploying computer-readable code into the computer system 400, wherein the code in combination with the computer system 400 is capable of performing a method of estimating health care costs of a patient.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for estimating health care costs of a patient comprising the steps of:
collecting, by a processor, symptom data from the patient;
analyzing, by the processor, the symptom data;
diagnosing, by the processor, a most probable disorder of the patient as a function of the symptom data;
retrieving, by the processor, an insurance cost schedule for each healthcare provider accessible to the patient;
calculating, by the processor, a cost for treating the most probable disorder as a function of the insurance cost schedule for each healthcare provider accessible to the patient; and
transmitting, by the processor, the cost for treating the most probable disorder estimated by each healthcare provider to the patient.

2. The method of claim 1, wherein the step of collecting further includes the steps:
measuring physiological data of the patient using a diagnostic device electronically coupled to the processor, wherein the physiological data is selected from the group consisting of heart rate, blood pressure, temperature, blood glucose level, pulse, muscle tension and neuronal activity.

3. The method of claim 1, wherein the step of analyzing the symptom data includes applying the symptom data to an analytics model to identify the most probable disorder.

4. The method of claim 3, wherein the step of diagnosing the disorder is a function of machine learning based on a repository of symptom data comprising previously confirmed diagnoses; and
comparing, by the processor, the symptom data with the repository of symptom data.

5. The method of claim 1, further comprising the steps of:
retrieving, by the processor, an availability schedule from each healthcare provider;
transmitting by the processor, each availability schedule provided by the healthcare provider to the patient;
receiving, by the processor, patient input selecting a healthcare provider from the availability schedule; and
scheduling, by the processor, treatment of the most probable disorder with the healthcare provider as a function of the patient input.

6. The method of claim 1, wherein the cost of each healthcare provider is an estimated cost for treating the disorder diagnosed in the diagnosing step and the estimated cost is displayed via a display device to the patient, prior to receiving an evaluation by a medical professional.

7. The method of claim 1, wherein the step of diagnosing provides a second diagnosis of the disorder that is a next most probable disorder as a function of analyzing the symptom data.

8. The method of claim 1, further comprising providing at least one support service for at least one of creating, integrating, hosting, maintaining, and deploying computer-readable program code in a computer system, where the computer-readable program code in combination with the computer system is configured to implement the steps of collecting, analyzing, diagnosing, retrieving, calculating, and transmitting.

9. A computer system, comprising:
a processor;
a memory device coupled to the processor;
a diagnostic device electronically coupled to the processor and
a computer readable storage device coupled to the processor, wherein the storage device contains program code executable by the processor via the memory device to implement a method for estimating health care costs of a patient comprising the steps of:
collecting, by a processor, symptom data from the patient via the electronic diagnostic device;
analyzing, by the processor, the symptom data;
diagnosing, by the processor, a most probable disorder of the patient as a function of the symptom data;
retrieving, by the processor, an insurance cost schedule for each healthcare provider accessible to the patient;
calculating, by the processor, a cost for treating the most probable disorder as a function of the insurance cost schedule for each healthcare provider accessible to the patient; and
transmitting, by the processor, the cost for treating the most probable disorder estimated by each healthcare provider to the patient.

10. The computer system of claim 9, wherein the step of collecting further includes the steps:
measuring physiological data of the patient using the diagnostic device, wherein the physiological data collected is selected from the group consisting of heart rate, blood pressure, temperature, blood glucose level, pulse, muscle tension and neuronal activity.

11. The computer system of claim 11 wherein the step of diagnosing the disorder is a function of machine learning based on a repository of symptom data comprising previously confirmed diagnoses; and
comparing, by the processor, the symptom data with the repository of symptom data.

12. The method of claim 9, further comprising the steps of:
retrieving, by the processor, an availability schedule from each healthcare provider;
transmitting by the processor, each availability schedule provided by the healthcare provider to the patient;
receiving, by the processor, patient input selecting a healthcare provider from the availability schedule; and
scheduling, by the processor, treatment of the most probable disorder with the healthcare provider as a function of the patient input.

13. The computer system of claim 9, wherein the cost of each healthcare provider is an estimated cost for treating the disorder diagnosed in the diagnosing step and the estimated cost is displayed via a display device to the patient, prior to receiving an evaluation by a medical professional.

14. The computer system of claim 9, wherein the step of diagnosing further provides a second diagnosis of the disorder that is a next most probable disorder as a function of analyzing the symptom data.

15. A computer program product comprising:
one or more computer readable hardware storage devices having computer readable program code stored therein, said program code containing instructions executable by one or more processors to implement a method for estimating health care costs of a patient comprising the steps of:
collecting, by a processor, symptom data from the patient;
analyzing, by the processor, the symptom data;
diagnosing, by the processor, a most probable disorder of the patient as a function of the symptom data;
retrieving, by the processor, an insurance cost schedule for each healthcare provider accessible to the patient;
calculating, by the processor, a cost for treating the most probable disorder as a function of the insurance cost schedule for each healthcare provider accessible to the patient; and
transmitting, by the processor, the cost for treating the most probable disorder estimated by each healthcare provider to the patient.

16. The computer program product of claim 15, wherein the step of collecting further includes the steps:
measuring physiological data of the patient using a diagnostic device electronically coupled to the processor, wherein the physiological data is selected from the group consisting of heart rate, blood pressure, temperature, blood glucose level, pulse, muscle tension and neuronal activity.

17. The computer program product of claim 15, wherein the step of diagnosing the disorder is a function of machine learning based on a repository of symptom data comprising previously confirmed diagnoses; and
comparing, by the processor, the symptom data with the repository of symptom data.

18. The computer program product of claim 15, further comprising the steps of:
retrieving, by the processor, an availability schedule from each healthcare provider;
transmitting by the processor, each availability schedule provided by the healthcare provider to the patient;
receiving, by the processor, patient input selecting a healthcare provider from the availability schedule; and
scheduling, by the processor, treatment of the most probable disorder with the healthcare provider as a function of the patient input.

19. The computer program product of claim 15, wherein the cost of each healthcare provider is an estimated cost for treating the disorder diagnosed in the diagnosing step prior to receiving an evaluation by a medical professional.

20. The computer program product of claim 15, wherein the step of diagnosing provides a second diagnosis of the disorder that is a next most probable disorder as a function of analyzing the symptom data.
